(19) United States
(12) Patent Application Publication
(10) Pub. No.: US 2008/0065347 A1
(43) Pub. Date: Mar. 13, 2008

(54) Statistical Surface-Scanning Method And System

(76) Inventors: Erwann Lavarec, Montpellier (FR); Frederic Vautard, Saint-Drezery (FR)

Correspondence Address: FULBRIGHT & JAWORSKI, LLP, 666 FIFTH AVE, NEW YORK, NY, 10103-3198, US

(21) Appl. No.: 10/578,220

(22) PCT Filed: Oct. 19, 2004
(86) PCT No.: PCT/FR04/50515

§ 371 Date: Mar. 5, 2007

(30) Foreign Application Priority Data
Nov. 3, 2003 (FR) 0350777

(51) Int. Cl. G01B 11/00

(52) U.S. Cl. 702/155; 901/46

(57) ABSTRACT

The invention relates to a method of scanning a complex surface (202) defined at least partially by a physical barrier and/or comprising obstacles. The inventive method comprises the following steps: (a) a step consisting in sufficiently scanning a first zone such as to obtain absolute location data in said zone, thereby enabling same to be exhaustively scanned; (b) a step consisting in selecting a second zone (206i+1) of the complex surface, having a reduced size and a suitable shape, and repeating step (a) for said second zone; and (c) a step consisting in repeating step (b) as many times as is necessary for the whole complex surface to be scanned.

### AREA OF THE INVENTION

This present invention concerns the area of robotics. More particularly it concerns a process and a system implemented by a mobile robot designed to scan a complex surface, that is to traverse this complex surface in an independent manner to an extent that is sufficiently exhaustive to effect a treatment of the latter during this journey.

### THE PROBLEM, AND PRIOR ART

In many applications, particularly in the area of domestic and garden equipment, it is necessary to design independent equipment, such as vacuum cleaning robots, known in what follows as mobile robots, capable of traversing, in a virtually exhaustive manner, a complex surface that includes obstacles (such as the floor of a furnished room).

To this end, we are familiar with systems and procedures for the traversing of complex surfaces employing sensors which are used to scan the environment (particularly the walls of the room and the furniture located within it) and to record the relative position of the robot in relation to this environment.

However, in order for a robot to effect an exhaustive scan of a surface to be treated, it is necessary that it can be fitted with sensors that supply its absolute position. However given their purchase price, such absolute position sensors are not very suitable for the creation of equipment designed for mass production.

Furthermore, we are also familiar with computing systems which determine the location of a mobile robot by integrating a series of relative positions of this robot from an initial position.

At this stage, it should be noted that the integration of successive positions is effected by odometry (dead reckoning), that is by making use of the parameters measured on this robot, such as the number of wheel revolutions of the robot and the angles of rotation of its directional wheels, in order to determine its movement in relation to an initial point.

However, the systems calculating the location of a robot by integrating a series of relative positions have the disadvantage of accumulating errors over time, with the result that after a certain distance, the absolute location includes an error arising mainly from the integration of noise from the sensors used.

Finally, it should be noted that low-noise sensors do exist, but given their purchase price, these sensors are not very suitable for the creation of equipment designed for mass production.

### THE INVENTION

The precise purpose of this invention is to create systems and procedures for the scanning of complex surfaces by the use of low-cost relative-position sensors, despite the technical drawbacks of the latter as described above.

### THE SOLUTION

The invention concerns a process for scanning a complex surface which is delimited, at least in part, by a physical barrier and/or that includes obstacles, where this process includes the following stages:

(a) a stage for scanning, in a suitable manner, a first zone, of small dimensions and of appropriate shape, of the complex surface,

where appropriate, detecting the physical barrier and/or the obstacles,

travelling through successive relative positions, and

integrating these relative positions.

(b) a stage for selecting a second zone of small dimensions, and of appropriate shape, of the complex surface, and to iterate the above stage (a) for this second zone,

(c) a stage to iterate stage (b) as often as necessary in order to scan the whole of the complex surface.

In one method of implementation, the process also includes a stage for choosing the dimensions and the shape of each zone so that the error over the course of time, which results from the integration of a series of relative positions, remains less than a specified threshold.

According to one method of implementation, in the case where a scan zone contains all or part of an obstacle, the process also includes the following stages:

a stage for scanning the zone while remaining, as far as is possible, within the zone concerned and following all or part of the contours of the obstacle in the zone, and then

a stage for selecting the next zone by applying travel rules.

According to one implementation, the process also includes a stage for selecting the second zone by the execution of a random selection process.

In one implementation, the process also includes a stage for selecting the second zone by effecting the selection of a contiguous zone in a predetermined strip progressing in a set direction, and then selecting another strip, at random for example.

According to one implementation, the process includes a strip-changing stage when (i) a wall or an obstacle of a dimension or size which is large in relation to that of the scanned zone is detected in the scanned zone and/or (ii) a strip is found which has already been scanned.

In one implementation, in order to select the second zone, the process includes a stage for establishing, in a dynamic manner during the scan, a map of the environment which can be used to apply the travel rules in the different zones comprising the complex surface and taking account of the obstacles, and then a stage for selecting the second zone according to travel rules.

According to one implementation, the process for selection of the zone includes a random phase, and the process also includes a stage to halt the scan after a time which is greater than a set threshold.

In one implementation, the process includes a stage for effecting a circuit of the contours of the complex surface after completion of the scan.

The invention also concerns a system for scanning a complex surface which is delimited, at least in part, by a physical barrier and/or that includes obstacles, where this system includes:

(a) scanning resources that include detection resources used to detect the physical barrier and/or the obstacles, where the scanning resources are used to scan, in a suitable manner, a first zone of small dimensions and appropriate shape, of the complex surface,

travelling through successive relative positions, and

integrating the said relative positions,

b) selection resources in order to select a second zone, of small dimensions and appropriate shape, of the complex surface, and to iterate the above stage (a) for this second zone,

c) iteration resources to iterate stage (b), as often as necessary so as to scan the whole of the complex surface.

In one implementation, the system includes computer processing resources to choose the dimensions and the shape of each zone, so that the error over the course of time, resulting from the integration of a series of relative positions, remains less than a specified threshold.

In one implementation where a scan zone contains all or part of an obstacle, the system includes scanning resources to scan the zone while remaining, as far as is possible, within the zone concerned and following all or part of the contours of the obstacle in the zone, with the selection resources selecting the next zone by applying travel rules.

In one implementation, the selection resources selecting the second zone effect a random selection.

In one implementation, the selection resources select the second zone by effecting the selection of a contiguous zone in a predetermined strip, progressing in a set direction and then selecting another strip, at random for example.

In one implementation, the computer processing resources include computing resources to change the strip when (i) a wall or an obstacle, of a dimension or size which is large in relation to that of the scanned zone, is detected in the scanned zone and/or (ii) a strip is found which has already been scanned.

In one implementation, the system includes computer processing resources which include computing resources used:

to establish, in a dynamic manner during the scan, a map of the environment which can be used to apply the travel rules in the different zones comprising the complex surface, taking account of the obstacles, and then

to select the second zone according to travel rules.

In one implementation, the process for selection of the zone and/or of the strip includes a random phase, and the system includes computer processing resources to halt the scan after a time which is greater than a set threshold.

In one implementation, the system includes computer processing resources used to perform a circuit of the contours of the complex surface after completion of the scan.

According to one implementation, the scanning resources are used to calculate, in a dynamic manner, a map of the complex surface from data supplied by the detection resources during the scan of the complex surface.

In one implementation, the detection resources include an infrared radiation emitter, and an infrared radiation receiver detecting the infrared radiation reflected by the concerned parts of the physical barrier or of the obstacle, with the computer processing resources being used to gradually vary the power of the infrared radiation sent out by the emitter up to a power that is sufficient to detect the concerned parts of the physical barrier or of the obstacle, while the computing resources are used to determine the relative position of the concerned parts of the physical barrier or of the obstacle in relation to the mobile robot as a function of the value of the detected power.

It is thus possible, in a dynamic manner, as the robot is moving over the surface:

to determine the geometrical data (angles, lengths, etc.) characterising the geometry of the obstacles or of the physical barrier, and/or

to construct a map of the complex surface.

Finally, the invention concerns any application of the process and/or of the system described in any of the foregoing implementations of the use of a robot or automatic system for the treatment of flat and/or warped surfaces, of a robot or automatic system for the treatment of wild or cultivated land, of a vacuum-cleaning robot or system, of a robotic lawn mower, of a robot or automatic system for the washing of horizontal or inclined walls, particularly of the glazed or ceiling or roof type, or of a robot or automatic system for the decontamination of complex contaminated surfaces.

### ADVANTAGES OF THE INVENTION

The implementation of a process or of a system according to the invention by a mobile robot has the advantage of enabling the latter to scan a surface exhaustively, that is to effect an adequate scan of the whole of this surface in relation to the treatment of the surface covered, with use being made by this robot of low-cost relative position sensors.

In fact, the sensor error included in the location of the robot corresponds to the error associated with the scanning of a zone. Now the error associated with the scanning of a zone is less than the scanning error for the whole of the surface, so that, from the movement data of the robot (number of wheel revolutions, changes of direction, etc.), it is possible to compensate for the errors in the sensors.

In other words, by limiting the scan to a first zone of small dimensions in relation to the complex surface, and of appropriate shape, it is possible to obtain a precise location in this first zone using low-cost location resources, in order to effect an exhaustive scan of the latter.

### FIGURES

Other characteristics and advantages of the invention will appear from the description of this invention provided below by way of information only and in a non-limited manner, with reference to the attached figures in which:

FIGS. 1a, 1b, 1c and 1d are diagrams of the scanning of a zone of small dimensions of a complex surface scanned according to the invention,

FIG. 2 is a diagram of the scanning of a complex surface in a random movement according to the invention,

FIG. 3 is a diagram of scanning in the form of strips according to the invention,

FIGS. 4a and 4b are diagrams of the scanning of a complex surface according to two variants of movement by strips according to the invention, and

FIG. 5 is a diagram of a process for the creation of a map using a process according to the invention.

### DESCRIPTION OF METHODS OF IMPLEMENTATION OF THE INVENTION

In the description of the invention given below, we are considering a complex surface, that is one which, for example, may have irregularities and/or variations of gradient, and limited at least partially by a physical barrier such as a wall or a gap or change of direction in the complex surface.

The nature of this surface, which can be flat and/or warped, varies as a function of the application in which a system according to the invention is used. Thus, such an application can relate to a robot used to treat wild or cultivated land, to a vacuum-cleaning robot, to a robotic lawn mower, to a robot employed to wash horizontal or inclined walls, particularly of the glazed or ceiling or roof type, or indeed to a robot for the decontamination of complex contaminated surfaces.

Furthermore, this surface can include one or more obstacles which, similarly to the physical barrier, limit the movement of the robot requiring to scan this surface, that is requiring to traverse the surface concerned while applying a treatment to this surface.

This is why we are considering as an obstacle any element which prevents the movement of the robot over the whole of the complex surface. Thus, an obstacle can take the form of a physical object or a gap or change of direction.

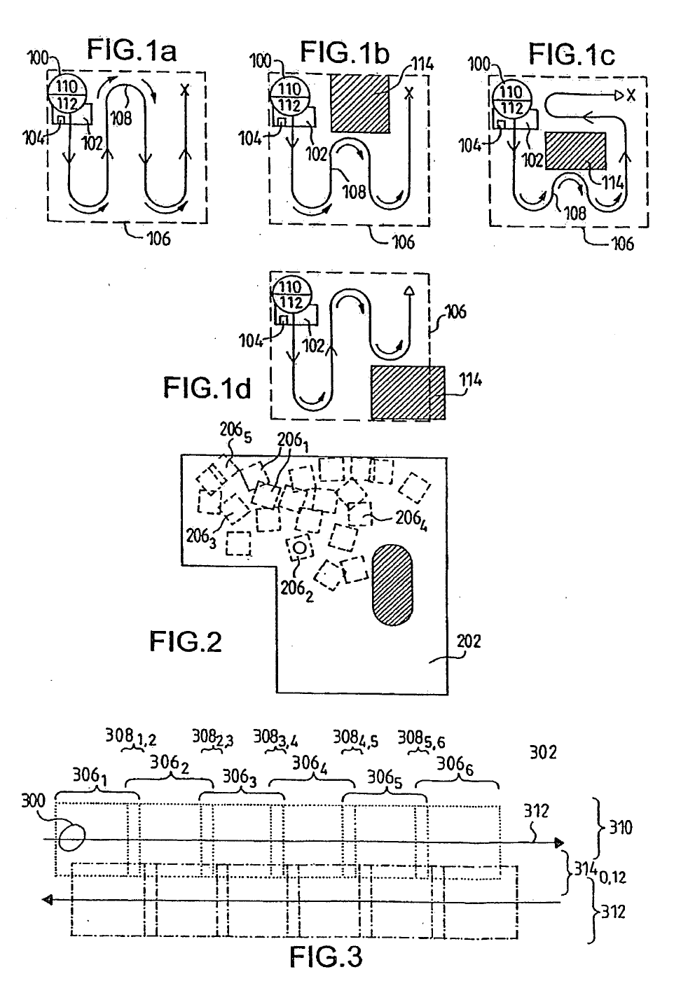

To scan a surface, a robot 100 (FIG. 1a) according to the invention includes scanning resources 102 that have detection resources 104 used to detect a physical barrier or an obstacle.

In addition, the scanning resources 102 are used to scan, in a suitable manner, a first zone 106, of small dimensions and of appropriate shape, of the complex surface, travelling through successive relative positions to form a journey 108, and then integrating these relative positions.

At this stage, it should be recalled that a mobile robot 100 can determine its location in relation to a starting point by odometry, that is by integrating information such as the number of revolutions of its driving wheels or the changes of direction of its directional wheels, measured from its movements.

Furthermore, by establishing the position of the robot 100 in a zone 106 of small dimensions and of appropriate shape, we get a precise location of the robot 100 in this zone, enabling it to execute an exhaustive scan, that is one which is adequate for the application effected by the robot 100.

In fact, determination of the position of the robot 100 by odometry produces a smaller error for a zone 106 of small dimension than for the complex surface that includes this zone 100.

In practice, it turns out that a zone 106 of rectangular or square shape can be used to implement the invention simply by considering that the length of this zone 106 must be equivalent to four times the largest operational dimension, perpendicular to the axis of movement, of the treatment tool over the surface.

Considering a vacuum-cleaning robot with a maximum dimension of 30 cm and scanning a width of 25 cm, with drive and odometry resources that create an error or deviation of 1% over one metre, it emerges that a square zone with dimensions of one metre by one metre allows this robot to scan this surface following a shuttling trajectory, as shown in FIG. 1a, with an odometry location error of less than 5%.

The example given above can be generalised to the determination of any shape (round, square, rectangle, triangular, etc.) and the dimensions of a zone, by considering that the error resulting from the integration effected by the robot scanning this zone must not exceed a certain threshold.

This is why, in this implementation, the robot 100 includes computer processing resources 112 to choose the dimensions and the shape of each zone so that the error over the course of time, resulting from the integration of a series of relative positions, remains less than a specified threshold.

Furthermore, when a zone 106 to be scanned contains all or part of an obstacle 114, the scanning resources 102 ensure that the scanning of the zone is effected by remaining, as far as is possible, within the zone concerned and following all or part of the contours of the obstacle in the zone, as described in detail above with reference to FIGS. 1b, 1c and 1d.

These FIGS. 1b, 1c and 1d show the robot 100 in the zone 106 as previously described in FIG. 1a. However, an obstacle 114 is present at one edge (FIG. 1b), on the inside (FIG. 1c) or in a corner (FIG. 1d) of this zone 106.

Considering the case where the obstacle 114 is present at one edge of the zone 106, the robot 100 scans the part of this zone 106 which is accessible to it, following the contour of the obstacle 114, so that the robot meets the trajectory designed for the zone 106 in the absence of any obstacles (FIG. 1a).

However when the robot 100 encounters an obstacle 114 within the zone 106 (FIG. 1c), the robot follows the contour of this known obstacle 114, previously described, until it detects an opportunity to effect the scan that the obstacle 114 had prevented, in which case the robot 100 effects a scan of the whole contour of the obstacle 114 before continuing the scan of the zone 106.

As indicated previously, the robot 100 remains, as far as is possible, within a zone during its scan so that, when the latter encounters an obstacle 114 which projects outside the zone 106 during the scan (FIG. 1d), the robot finalises the scan of the zone being treated without seeking to scan the whole of the contour of the obstacle 114, which would involve other zones.

In other words, the robot is not prevented from exiting partially outside the zone in order to skirt the obstacle. However, the robot is only allowed to leave the zone as long as the errors do not exceed the set thresholds.

According to the invention, the robot 100 also includes selection resources 110 in order to select a second zone, of small dimensions and of appropriate shape, of the complex surface, and to iterate, for this second zone, the exhaustive scanning stage already effected for the first zone.

Then, by iterating as many times as necessary the operations for selection and scanning of successive zones using iteration resources 112, the robot scans the whole of the complex surface.

It therefore emerges that the selection resources of a robot according to the invention are able to select the next zone to be scanned by applying travel rules, selecting these zones, for example, so that they form a strip, as described above.

In a first example of implementation shown in FIG. 2, the selection resources 210 of a robot 200 according to the invention select the second zone by the execution of a random selection process.

Thus, when the robot 200 has finished scanning a zone 206ᵢ as indicated previously, the selection rules determine that this robot 200 moves randomly over the surface 202 to treat a new zone 206ᵢ₊₁.

Such a random process has the advantage of using a simple algorithm which requires small computing and memory capacity, thus reducing the cost of the robot 200 and, as a consequence, the cost of treating the surface 202.

In this case, the robot 200 can include stop resources such that treatment of the surface is considered to be completed after a time that is greater than a set threshold.

In addition, in this implementation, the robot includes computer resources to halt the scan after a time which is greater than a set threshold, with this threshold being determined, for example, as a function of the probability with which one wishes the whole of the complex surface to be scanned.

In another implementation, the robot 300 includes selection resources which select the second zone by effecting the selection of a contiguous zone in a predetermined strip progressing in a set direction, covered as described above with reference to FIG. 3.

FIG. 3 shows a robot 300 scanning a surface 302, considering zones 306ᵢ and 306ᵢ₊₁ to be contiguous and such that it presents common parts 308_{i;i+1}.

In fact, according to a variant of the invention, a zone 306ᵢ₊₁ is defined so that it has a part 308_{i;i+1} which as already been scanned during the treatment of a previously concerned zone 306ᵢ.

Thus, a robot according to the invention exhaustively scans the whole of the complex surface 302 treated, that is leaving no part of this surface unscanned.

Furthermore, at this stage of the description, it should be emphasised that when different cleaning strips 310 and 312 are used to scan a surface 302, these strips are contiguous and such that they have a common part 314_{10;12} in order to guarantee exhaustive scanning of the surface.

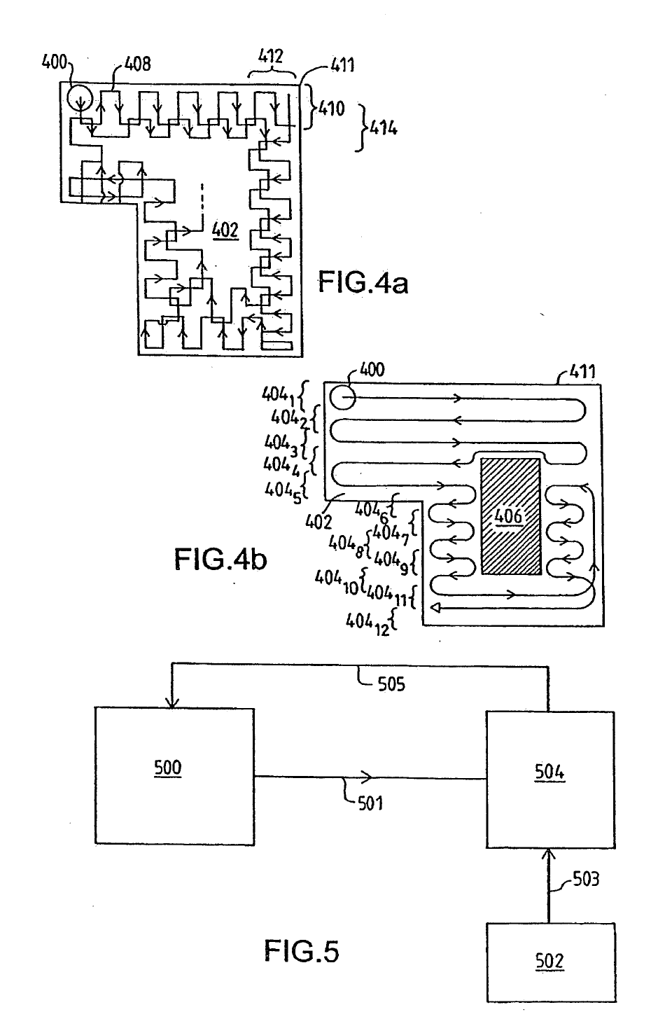

A first example of scanning by strips is shown in FIG. 4a. According to this example, a robot 400 executes a scan whose trajectory 408 over the surface 402 forms strips 410, 412 and 414.

These strips are composed of zones as represented in dotted lines. These zones are scanned successively as the robot advances in a set direction. The trajectory observed, in the shape of castellations, is the resultant of the different shuttle trajectories in the zones making up the strip.

In addition, the robot 400 includes computing resources employed to change strip, that is to change direction when a wall or an obstacle of a dimension or size which is large in relation to that of the scanned zone is detected in the scanned zone, and/or a strip is found which has already been scanned.

Thus, when the robot traverses a first strip 410 and reaches the physical barrier 411 of the surface 402, it changes the direction of its scan in one strip in order to scan a new strip 412.

As an example, the robot 400 can thus follow the contour of the surface 402 by following this physical barrier 411 and then, when it reaches a strip 410 which has already been completed, it changes to scan a strip 414 which is contiguous to this strip 410 as described with reference to FIG. 3.

In this way, the robot scans the whole of the complex surface 402, though for reasons of clarity, this is has not been illustrated.

According to a second example of scanning by strips, shown in FIG. 4b, a robot 400 scans the surface 402 to form parallel strips 404ᵢ and 404ᵢ₊₁, each strip being represented only by its direction of travel during the scan by the robot 400.

If the mobile robot 400 is limited in its progression along a strip 404₄ by an obstacle 406, it skirts this obstacle without needing any change of strip.

In fact, if the obstacle is of small dimension, the robot continues its advance remaining within the same strip while, if the obstacle is of large dimension, the robot changes strip, continuing its trajectory as if it had encountered a physical barrier.

As an example, if the progression along a strip 404₅ is impeded by an obstacle 406 and the robot 400 is unable skirt the latter without changing strip, then the robot 400 continues its scan as if the obstacle 406 constituted a physical barrier.

When the robot scans a strip 404₁₁ no longer encountering obstacle 406, it skirts this so as to scan strip 404′₅ and strip 404′ᵢ, which correspond to the extension of strips 404₅ to 404′₁₀ interrupted by obstacle 406.

When the robot has scanned these interrupted strips 404₅ to 404′₁₀, it continues to scan surface 400 by continuing its progression in parallel strips from strip 400₁₁, not having been limited by obstacle 406.

In this preferred implementation of the invention, the robot 400 includes computer processing resources which enable it to establish a map of its environment in a dynamic manner while scanning the surface and particularly a map of the layout of the physical barrier and of any obstacles included in the scanned surface.

This map can be created, for example, in such a manner that the scanning resources can create, in a dynamic manner, this map of the complex surface from data supplied by the detection resources while scanning the complex surface, as described in detail above with reference to FIG. 5.

FIG. 5 shows a database 500 which includes pre-established information 501 relating to the geometry of a surface to be scanned, as well as a base 502 which records the information 503 relating to the measurements effected by the different sensors and probes of the robot.

By comparing this pre-established and measured information 501 and 503, a comparator 504 is able to update the information 501 recorded in the base 500, in order, for example, to store the movement of an obstacle in relation to a previous scan of the surface.

In addition, the robot is able to apply travel rules, that is rules relating the manner in which a second zone is selected from a first zone, allowing for any obstacles.

In one preferred method of implementation, the detection resources include a device which is similar to that described in patent application FR 01/01065, entitled “Process and device for the detection of an obstacle, and for measurement of distance by infrared radiation”, submitted on 26 Jan. 2001 on behalf of Wany SA (France) and published on 2 Aug. 2002, namely an infrared radiation emitter, and an infrared radiation receiver detecting the infrared radiation reflected by the concerned parts of the physical barrier or the obstacle.

The computer processing resources of the robot gradually vary the power of the infrared radiation sent out by the emitter up to a power that is sufficient to detect the concerned parts of the physical barrier or obstacle.

Thus, the computing resources are able to determine the relative position of the concerned parts of the physical barrier or an obstacle, in relation to the mobile robot, as a function of the said value of the detected power.

Thus, it is possible, in a dynamic manner, as the robot is moving over the surface, to determine the geometrical data (angles and lengths, etc.) characterising the geometry of any obstacles or of the physical barrier, and/or to construct a map of the complex surface.

Furthermore, it should be emphasised at this stage that when the robot positions itself in relation to the physical barrier or to an obstacle already identified by means of its sensors and/or probes, it executes an absolute location operation which has the effect of cancelling any error arising from integration by odometry.

This present invention is open to many variants. Thus, when a robot scans a surface using strips, and the selection of a strip to be scanned includes a random phase, the robot can include computer processing resources in order to halt the scan after a time which is greater than a set threshold.

According to another implementation, a robot according to the invention includes computer processing resources to effect a circuit of the contours of the complex surface after completion of the scan.

Such a scan can be implemented using a map of the surface covered by the robot as previously described, and/or using sensors that enable the robot to follow the contours of the complex surface, such as when the latter are walls for example.

1. A process employed to scan a complex surface (202, 302, 402) which is delimited at least in part by a physical barrier (411) and/or that has obstacles (114, 406); where the said process includes the following stages:
(a) a stage for scanning, in a suitable manner, a first zone (106, 206ᵢ, 306ᵢ), of small dimensions and of appropriate shape, of the said complex surface,
where appropriate, detecting the said physical barrier (411) and/or the said obstacles (114, 406), and
travelling through successive relative positions,
and integrating the said relative positions;
in such a manner that enables an absolute position to be established in the said first zone, enabling us to achieve an exhaustive scan of the said first zone;
where the said process also includes:
(b) a stage for selecting a second zone (206ᵢ₊₁, 306ᵢ₊₁) of small dimensions and of appropriate shape, of the said complex surface, and for iterating the above stage (a) for this second zone,
(c) a stage to iterate stage (b) as often as necessary in order to scan the whole of the complex surface.

2. A process according to claim 1, in which the said process also includes:
(d) a stage for choosing the dimensions and the shape of each zone (106, 206ᵢ, 206ᵢ₊₁, 306ᵢ, 306ᵢ₊₁) so that the error over the course of time, resulting from the integration of a series of relative positions, remains less than a specified threshold.

3. A process according to one of claims 1 or 2; in the case where a scan zone contains all or part of an obstacle (114, 406), where the said process also includes the following stages:
stages for scanning the zone while remaining, as far as possible, within the zone concerned and following all or part of the contours of the obstacle in the zone, and then
a stage for selecting the next zone by applying travel rules.

4. A process according to any one of claims 1 to 3; where the said process also includes:
a stage for selecting the said second zone (206ᵢ₊₁, 306ᵢ₊₁) by the execution of a random selection process.

5. A process according to any one of claims 1 to 3; where the said process also includes:
a stage for selecting the said second zone (206ᵢ₊₁, 306ᵢ₊₁) by effecting the selection of a contiguous zone (308_{i;i+1}) in a predetermined strip (310) progressing in a set direction and then selecting another strip(312), at random for example.

6. A process according to claim 5, where the said process also includes:
a strip-changing stage (412, 404₅) when (i) a wall (411) or an obstacle (406) of a dimension or size which is large in relation to that of the scanned zone, is detected in the scanned zone and/or (ii) when a strip (404₆) is encountered which has been scanned already.

7. A process according to any one of claims 1 to 6; in order to select the said second zone, where the said second process also includes:
a stage to establish, in a dynamic manner during the scan, a map of the environment which can be used to apply the travel rules in the different zones comprising the complex surface, taking account of the obstacles, and then
a stage for selecting the second zone according to the said travel rules.

8. A process according to any one of claims 1 to 7; with the process for selection of the zone and/or of the strip including a random phase, where the said process also includes:
a stage to halt the scan after a time which is greater than a set threshold.

9. A process according to any one of claims 1 to 8; where the said process also includes a stage to effect a circuit of the contours of the complex surface after completion of the scan.

10. A system (100, 200, 300, 400) employed to scan a complex surface (202, 302, 402) which is delimited at least in part by a physical barrier (411) and/or that has obstacles (114); where the said system includes:
(a) scanning resources (102) that include detection resources (104) used to detect the said physical barrier and/or the said obstacles;
where the said scanning resources (102) enable us to scan, in a suitable manner, a first zone (206ᵢ, 306ᵢ) of small dimensions and of appropriate shape, of the said complex surface,
travelling through successive relative positions, and
integrating the said relative positions in such a manner that we thus get an absolute location in the said first zone, in order to effect an exhaustive scan of the said first zone;
where the said system also includes:
(b) selection resources (110, 210) used to select a second zone (206ᵢ₊₁, 306ᵢ₊₁) of small dimensions and of appropriate shape, of the said complex surface, and to iterate the above stage (a) for this second zone,
(c) iteration resources to iterate stage (b), as often as necessary, so as to scan the whole of the complex surface.

11. A system according to claim 10; where the said system also includes:
(d) computer processing resources (112) to choose the dimensions and the shape of each zone so that the error over the course of time, resulting from integrating the succession of relative positions, remains less than a specified threshold.

12. A system according to one of claims 10 or 11; in the case where a scan zone contains all or part of an obstacle, the said system also includes scanning resources (102) to scan the zone while remaining, as far as is possible, within the zone concerned, and following all or part of the contours of the obstacle in the zone, with the said selection resources selecting the next zone by applying travel rules.

13. A system according to any one of claims 10 to 12; with the said selection resources (110, 210) selecting the said second zone (206ᵢ₊₁) by the execution of a random selection process.

14. A system according to any one of claims 10 to 12, where the said selection resources (110, 210) select the said second zone (306ᵢ₊₁) by effecting the selection of a contiguous zone (308i_{;i+1}) in a predetermined strip (310) progressing in a set direction and then selecting another strip, at random for example.

15. A system according to claim 14, where the said computer processing resources (112) include computing resources to change strip when (i) a wall or an obstacle of a dimension or size which is large in relation to that of the scanned zone is detected in the scanned zone and/or (ii) a strip is found which has already been scanned.

16. A system according to any one of claims 10 to 15, where the said system includes computer processing resources (112), where the said computer processing resources (112) include computing resources used:
to establish, in a dynamic manner during the scan, a map of the environment which can be used to apply the travel rules in the different zones comprising the complex surface, taking account of the obstacles; and then
to select the second zone according to the said travel rules.

17. A system according to any one of claims 10 to 16; where the process for selection of the zone and/or of the strip includes a random phase, where the said system includes computer processing resources to halt the scan after a time which is greater than a set threshold.

18. A system according to any one of claims 10 to 17; where the said system includes computer processing resources used to perform a circuit of the contours of the complex surface after completion of the scan.

19. A system according to any one of claims 10 to 18; where the said scanning resources are used to calculate, in a dynamic manner, the said map of the complex surface from data supplied by the said detection resources while scanning the said complex surface.

20. A system according to any one of claims 10 to 19; where the said detection resources (104) include
an infrared radiation emitter,
an infrared radiation receiver detecting the infrared radiation reflected by the concerned parts of the physical barrier or obstacle;
where the said computer processing resources (112) are used to gradually vary the power of the infrared radiation emitted by the said emitter up to a power that is sufficient to detect the concerned parts of the physical barrier or of the obstacle, where the said computing resources are used to determine the relative position of the concerned parts of the said physical barrier or of the said obstacle, in relation to the said mobile robot, as a function of the said value of the detected power in such a manner that it is then possible, in a dynamic manner as the robot is moving over the surface:
to determine the geometrical data (angles and lengths, etc.) characterising the geometry of the obstacles or of the physical barrier, and/or
to construct a map of the complex surface.

21. Application of the process according to claims 1 to 9 or of the system according to claims 10 to 20 to the implementation of a robot or automatic system for the treatment of flat and/or warped surfaces, of a robot for the treatment of wild or cultivated land, of a vacuum-cleaning robot, of a robotic lawn mower, of a robot employed to wash horizontal or inclined walls, particularly of the glazed or ceiling or roof type, or of a robot for the decontamination of complex contaminated surfaces.
